(19) United States
(12) Patent Application Publication
(10) Pub. No.: US 2014/0294396 A1
(43) Pub. Date: Oct. 2, 2014

(54) SIGNAL RECEIVING STRUCTURE AND ELECTRONIC DEVICE HAVING THE SAME

(71) Applicant: Wistron Corporation, New Taipei City (TW)

(72) Inventors: XIAO-PING QIU, New Taipei City (TW); LIANG YANG, New Taipei City (TW); JII-BO CAO, New Taipei City (TW)

(73) Assignee: Wistron Corporation, New Taipei City (TW)

(21) Appl. No.: 14/086,211

(22) Filed: Nov. 21, 2013

(30) Foreign Application Priority Data
Mar. 28, 2013 (CN) 201320149188.7

(51) Int. Cl. H04B 10/60; H04B 10/114

(52) U.S. Cl. CPC H04B 10/60; H04B 10/1141
USPC 398/118

(57) ABSTRACT

A signal receiving structure and an electronic device having the same are disclosed. The signal receiving structure used for the electronic device to receive an infrared signal includes a signal receiving area, a first block, a second block, and a third block. The signal receiving area is used to receive the infrared signal. The first block is connected to the signal receiving area and the infrared signal is transmitted therethrough. The second block is connected to the first block. A specific angle is interposed between the first block and the second block, such that the infrared signal can be transmitted through the second block by total reflection. The third block is connected to the second block and has a signal output area for the infrared signal to emit by the signal output area after total reflection. The signal receiving area is smaller than the signal output area.

### BACKGROUND OF THE INVENTION

1. Field of the Invention

The present invention relates to a signal receiving structure and an electronic device having the same, particular to a signal receiving structure with a smaller signal receiving area and an electronic device having the same.

2. Description of the Related Art

With the evolution of technology, the use of infrared (IR) signal to remotely control an electronic device has been widely applied. As long as there is an area in the electronic device to receive infrared signals, along with a remote control having an infrared signal transmission device, the remote control can control the electronic device to perform a variety of functions. Taking television for example, a frame on the current TV display screen usually reserves an area for receiving infrared signals. In view of the development trend of display screen, the user wants the thickness of the screen to get thinner and the frame to get narrower. However, as a result, the frame area of display screen may be too small, making the infrared signal receiving area out of the scope of the frame area. As such, the newly developed frameless display screen is unable to have an infrared signal receiving area and cannot provide the remote control function.

Accordingly, it is necessary to devise a new signal receiving structure and an electronic device having the signal receiving structure to address the deficiency in the art.

### SUMMARY OF THE INVENTION

A major objective of the present invention is to provide a signal receiving structure having a smaller signal receiving area.

Another major objective of the present invention is to provide an electronic device having the aforementioned signal receiving structure.

To achieve the objectives described above, a signal receiving structure of the present invention is used in an electronic device to receive an infrared signal and send the signal to a signal receiving module. The signal receiving structure includes a signal receiving area, a first block, a second block, and a third block. The signal receiving area is used to receive the infrared signal. The first block is connected to the signal receiving area. The infrared signal is transmitted through the first block. The second block is connected to the first block. A specific angle is interposed between the second block and the first block, such that the infrared signal can be transmitted through the second block by total reflection. The third block is connected to the second block and has a signal output area for the infrared signal to transmit from the signal output area to the signal receiving module after total reflection. Specifically, the signal receiving area is smaller than the signal output area.

The electronic device in the present invention is used to receive infrared signals from the outside. The electronic device includes a signal receiving structure, a signal receiving module, and a signal processing module. The signal receiving structure includes a signal receiving area, a first block, a second block, and a third block. The signal receiving area is used to receive infrared signals. The first block is connected to the signal receiving area, and an infrared signal is transmitted through the first block. The second block is connected to the first block. A specific angle is interposed between the second block and the first block, such that the infrared signal can be transmitted through the second block by total reflection. The third block is connected to the second block and has a signal output area for the infrared signal to transmit from the signal output area after total reflection. Specifically, the signal receiving area is smaller than the signal output area. A signal receiving module is disposed on a circuit board adjacent to the signal output area to receive infrared signals transmitted from the signal output area. Also, a signal processing module is disposed on a circuit board for electrically connecting to the signal receiving module to process the infrared signal.

### BRIEF DESCRIPTION OF THE DRAWINGS

FIG. 1 is a view showing an electronic device having a signal receiving structure according to the present invention;

FIG. 1A is a lateral view showing A-A side of the electronic device in the present invention according to FIG. 1;

FIG. 2 is a view showing the signal receiving structure of the present invention receiving an infrared signal; and

FIG. 3 is a three-dimensional view showing the signal receiving structure according to the present invention.

### DETAILED DESCRIPTION OF THE PREFERRED EMBODIMENT

The aforementioned and other objectives, features, and merits of the invention will become more apparent from the following detailed description of each embodiment.

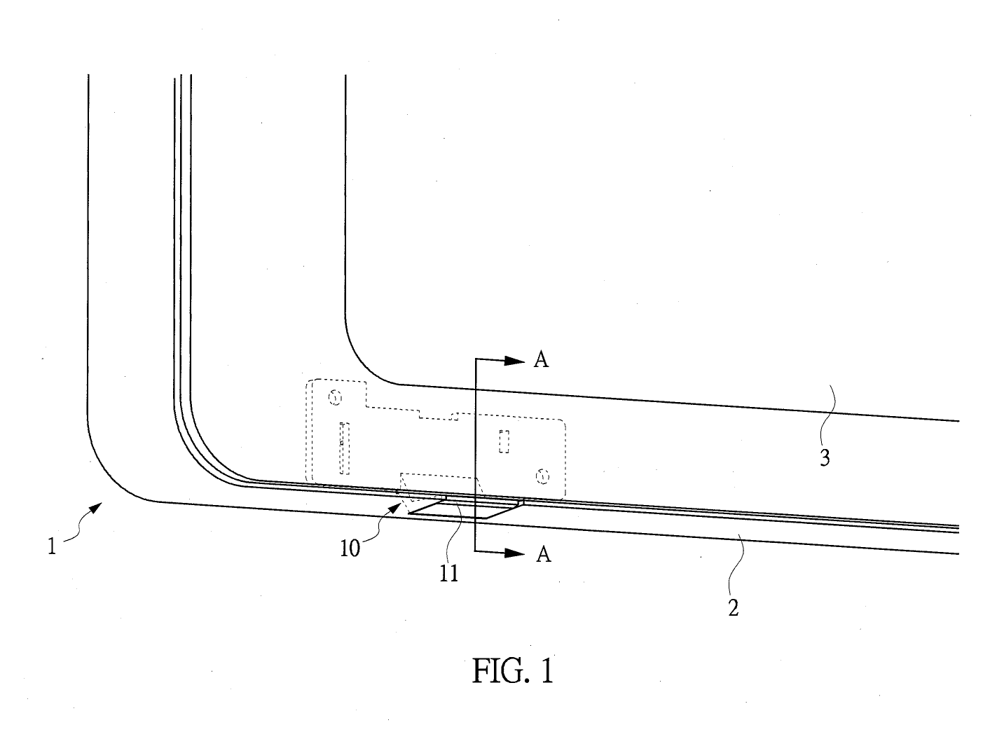

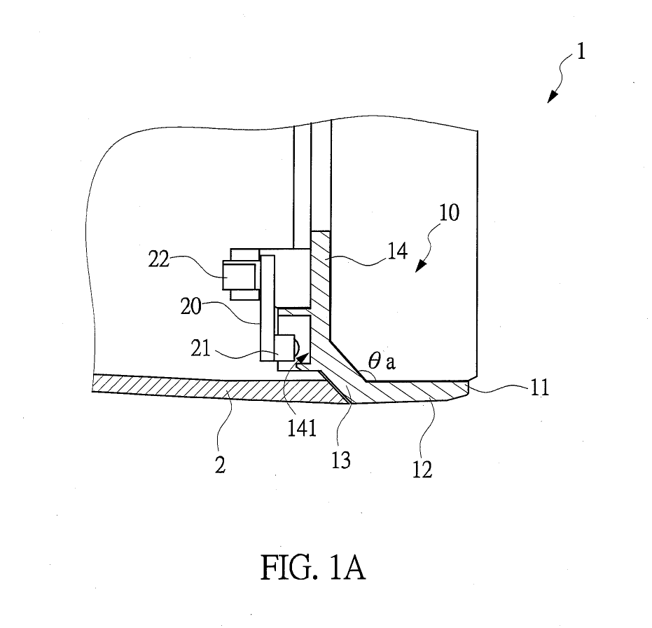

Hereinafter please first refer to FIG. 1, which is a view showing an electronic device having a signal receiving structure according to the present invention.

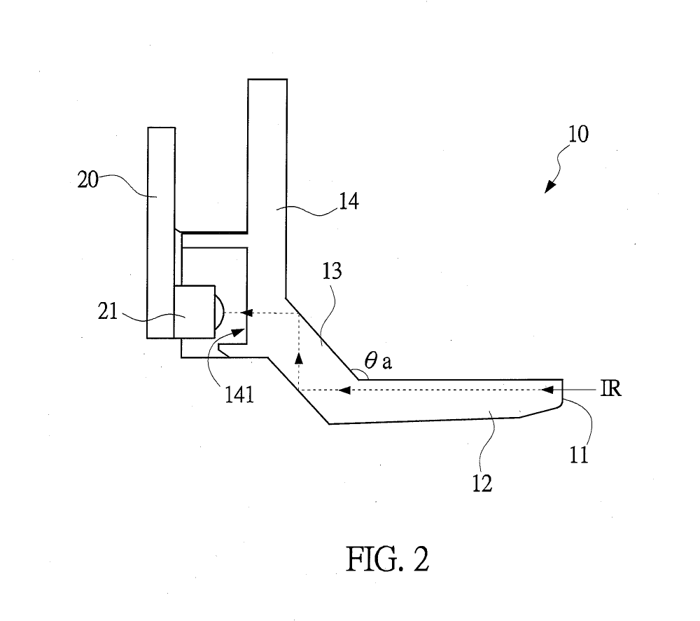

In FIG. 1, the electronic device 1 is used as a display for illustration, but the signal receiving structure 10 of the present invention is not limited to be used as a display. The exterior of the electronic device 1 includes a frame 2, a display panel 3, and a signal receiving structure 10. The display panel 3 is used to display the image; the frame 2 is used to protect the display panel 3. Since the imaging technology of the display panel 3 is not the focus the present invention wants to improve, its principle will not be detailed herein. The signal receiving structure 10 is disposed inside the frame 2, and only a signal receiving area 11 of the signal receiving structure 10 is exposed on the right side of the frame 2 to receive an infrared signal IR (as shown in FIG. 2).

Please also refer to FIG. 1A, which is lateral view showing A-A side of the electronic device in the present invention according to FIG. 1.

The signal receiving structure 10 can be made of transparent acrylic and divided into a signal receiving area 11, a first block 12, a second block 13, and a third block 14. The signal receiving area 11 is exposed on the right side of the frame 2 for directly receiving an infrared signal IR from the outside. In addition, the cross-sectional area of the signal receiving area 11 is not out of the range of the frame 2. In this way, from the front of the electronic device 1, the user may only observe the smaller signal receiving area 11 on the frame 2, and it is even not easy for the user to observe the position of the signal receiving area 11.

One end of the first block 12 is connected to the signal receiving area 11. An infrared signal IR received by the signal receiving area 11 is transmitted through the first block 12. The other end of the first block 12 is connected to the second block 13. Also, a specific angle θa is interposed between the first block 12 and the second block 13 such that the infrared signal IR can be incident and transmitted to the second block 13 by total reflection. The third block 14 is connected to one end of the second block 13 and has a signal output area 141. After the infrared signal IR passes through the second block 13, it also passes through the third block 14 and then is emitted by the signal output area 141. Also, the signal receiving area 11 is smaller than the signal output area 141. As a result, the frame of the electronic device only needs to have a small area of the signal receiving area 11, instead of reserving a larger signal output area 141. This can reduce the surface area of the frame 2.

Further, as shown in FIG. 1A, in addition to the frame 2, the display panel 3, and the signal receiving structure 10, the interior of the electronic device 1 includes a signal receiving module 21 and a signal processing module 22, wherein both of which are disposed on a circuit board 20 and are electrically connected to each other. The signal receiving module 21 is disposed adjacent to the signal output area 141, such that the infrared signal IR will be received by the signal receiving module 21 when it is emitted through the signal output area 141. The signal processing module 22 can be constituted of a chip hardware architecture. After the signal receiving module 21 receives the infrared signal IR, the signal processing module 22 can process the received infrared signal IR to control the electronic device 1 to perform the corresponding function.

Then, please refer to FIG. 2, which shows the signal receiving structure of the present invention receiving an infrared signal.

When the light passes through two media, the relationship between the incident angle and reflective angle can be obtained by the law of reflection: n1*sinθ1=n2*sinθ2, wherein n1 and n2 are refractive index of the two media; θ1 and θ2 represent the incident angle and reflective angle respectively. Accordingly, the formula of a critical angle θc can be obtained as follows: sin θc=n2/n1. The above formula has been widely used in the studies of physics and understood by persons of ordinary skill in the art, and thus will not be detailed herein.

In the case that the material of the signal receiving structure 10 is transparent acrylic, the refractive index is about 1.5. Accordingly, by the critical angle formula, the critical angle θc can be calculated as about 41.81°. As such, the specific angle θa interposed between the first block 12 and the second block 13 makes an incident angle of the infrared signal IR larger than 41.81°, such that the infrared signal IR generates the total reflection without energy loss due to refraction. As shown in FIG. 2, when the infrared signal IR is passed through the first block 12 and the second block 13, there are two total reflections, and then the infrared signal IR is emitted through the signal output area 141. Also, in an embodiment of the present invention, the incident angle of the infrared signal IR is larger than 45°. The specific angle θa interposed between the first block 12 and the second block 13 can be 135°, but the present invention is not limited to this. As a result, no matter the infrared signal IR is incident from the top or bottom of the signal receiving area 11, the infrared signal IR can be transmitted through the first block 12 and the second block 13 by total reflection, and finally out of the signal output area 141.

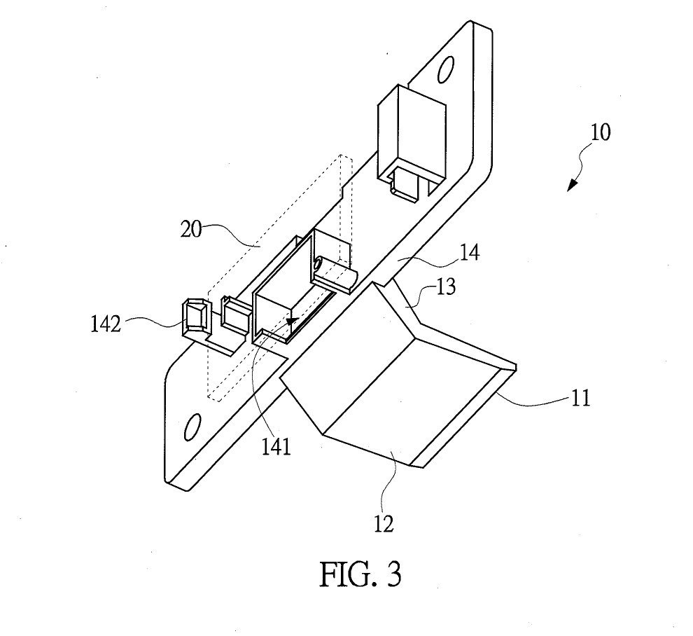

Finally, please refer to FIG. 3, which is a three-dimensional view of the signal receiving structure according to the present invention.

Furthermore, to make the signal receiving module 21 successfully receive the infrared signal IR , the third block 14 can also have a limit structure 142 for fixing the signal receiving structure 10 and the circuit board 20 to further fix the signal receiving module 21 to a specific position, i.e. where the signal output area 141 will send the infrared signal IR. As such, the infrared signal IR will be directly received by the signal receiving module 21 after it is emitted, which can avoid the unnecessary energy consumption of the infrared signal IR.

Through the signal receiving structure 10 and the electronic device 1 having the same described above, the present invention can reduce the exposed part of the signal receiving structure 10 on the right side of the electronic device 1, such that the design of the electronic device 1 can become more flexible and the appearance of the electronic device 1 can be improved. In addition, the signal receiving structure 10 can also avoid the weakening of the received infrared signal IR due to refraction.

As described above, the objectives, means, and effectiveness in the present invention are different to the characteristics in the prior art.

It should be noted that the embodiments described above are for illustrating the principles and effects of the present invention, not for limiting the scope of the present invention. Any person skilled in the art shall be able to make modifications and changes to the embodiments without departing from the technical principle and sprit of the present invention. The claims of the present invention within the scope of protection are described below.

What is claimed is:

1. A signal receiving structure used for an electronic device to receive an infrared (IR) signal and send the signal to a signal receiving module, the signal receiving structure comprising:
a signal receiving area for receiving the infrared signal;
a first block, connected to the signal receiving area, wherein the infrared signal is transmitted through the first block;
a second block, connected to the first block, wherein a specific angle being interposed between the second block and the first block, such that the infrared signal being transmitted through the second block by total reflection; and
a third block, which is connected to the second block and has a signal output area for the infrared signal to transmit from the signal output area to the signal receiving module after total reflection, wherein the signal receiving area being smaller than the signal output area.

2. The signal receiving structure as claimed in claim 1, wherein the material of the signal receiving structure is a transparent acrylic.

3. The signal receiving structure as claimed in claim 2, wherein the specific angle interposed between the first block and the second block makes an incident angle of the infrared signal larger than 45°.

4. The signal receiving structure as claimed in claim 3, wherein the specific angle interposed between the first block and the second block is 135°.

5. The signal receiving structure as claimed in claim 1, wherein the third block further has a limit structure used to fix a position of the signal receiving module.

6. The signal receiving structure as claimed in claim 1, wherein the electronic device has a frame, the signal receiving structure is disposed on the frame with only the signal receiving area exposed.

7. An electronic device having a signal receiving structure used for receiving an infrared signal from the outside, the electronic device comprising:
the signal receiving structure comprising:
a signal receiving area for receiving the infrared signal;
a first block connected to the signal receiving area, wherein the infrared signal is transmitted through the first block;
a second block connected to the first block, wherein a specific angle being interposed between the second block and the first block, such that the infrared signal being transmitted through the second block by total reflection; and
a third block, which is connected to the second block and has a signal output area, such that the infrared signal being transmitted from the signal output area after total reflection, wherein the signal receiving area being smaller than the signal output area;
a signal receiving module, disposed on a circuit board adjacent to the signal output area, is used for receiving the infrared signal transmitted from the signal output area; and
a signal processing module, disposed on the circuit board for electrically connecting the signal receiving module to process the infrared signal.

8. The electronic device having the signal receiving structure as claimed in claim 7, wherein the material of the signal receiving structure is transparent acrylic.

9. The electronic device having the signal receiving structure as claimed in claim 8, wherein the specific angle interposed between the first block and the second block makes an incident angle of the infrared signal larger than 45°.

10. The electronic device having the signal receiving structure as claimed in claim 9, wherein the specific angle interposed between the first block and the second block is 135°.

11. The electronic device having the signal receiving structure as claimed in claim 7, wherein the third block further has a limit structure fastened onto the circuit board for fixing the position of the signal receiving module.

12. The electronic device having the signal receiving structure as claimed in claim 7, wherein the electronic device has a frame, the signal receiving structure is disposed on the frame with only the signal receiving area exposed.
